(19) United States
(12) Patent Application Publication
(10) Pub. No.: US 2014/0082099 A1
(43) Pub. Date: Mar. 20, 2014

(54) MISPLACED MOBILE DEVICE NOTIFICATIONS BASED ON RIGHTFUL USER'S SOCIAL NETWORKING INFORMATION

(71) Applicant: INTERNATIONAL BUSINESS MACHINES CORPORATION, Armonk, NY (US)

(72) Inventors: Zachary Burns, New Paltz, NY (US); Yuk Lung Chan, Poughkeepsie, NY (US); Kin Choi, Poughkeepsie, NY (US); David J.B. Flaherty, Beacon, NY (US); Kevin H. Peters, Germantown, NY (US); Mark Allen Scott, Rhinebeck, NY (US)

(73) Assignee: INTERNATIONAL BUSINESS MACHINES CORPORATION, Armonk, NY (US)

(21) Appl. No.: 13/622,402

(22) Filed: Sep. 19, 2012

(51) Int. Cl. G06F 15/16

(52) U.S. Cl. 709/206

(57) ABSTRACT

In a method for notifying an owner or other rightful user of a mobile device of a misplaced mobile device, a computer receives social networking information about the rightful user of the mobile device. The computer receives, from the mobile device, a set of contextual information that is associated with the mobile device. The computer determines, based on the set of contextual information, whether the mobile device has been misplaced. In response to the computer determining that the mobile device has been misplaced, the computer dynamically identifies, based on the set of contextual information and on the social networking information, one or more contacts associated with the rightful user. In response to the computer determining that the mobile device has been misplaced, the computer sends a notification message to the identified one or more contacts. The notification message indicates that the rightful user's mobile device has been misplaced.

### TECHNICAL FIELD

The present invention relates generally to mobile devices and more specifically to physically locating a mobile device.

### BACKGROUND

The last several decades have witnessed not just an explosion in the number or type of electronic devices available to the consuming public, but also a corresponding reduction in the sizes of such devices. Today, the consuming public can acquire and use a wide variety of electronic devices, such as cellular phones, mobile phones, Wi-Fi phones, netbooks, laptop computers, handheld computers, tablet computers, such as the Apple iPad®, personal organizers, e-reading devices, such as the AMAZON KINDLE® and the BARNES & NOBLE® nook® devices (iPad® is a registered trademark of Apple Inc., located in Cupertino, Calif., AMAZON® and KINDLE® are registered trademarks of Amazon Technologies, Inc., located in Reno, Nev., nook® is a registered trademark of Fission LLC, located in New York, N.Y., and BARNES & NOBLE® is a registered trademark of Barnes & Noble Bookstores, Inc., located in New York, N.Y.) media players and gaming devices. Many of these devices are capable of wireless telecommunications. For example, cellular or mobile phones are capable of telephonic and data communication over a cellular telecommunications network. Some dual-mode cellular or mobile phones are additionally capable of wireless communications over Wi-Fi. Similarly, e-reading devices can engage in data communications over cellular telecommunications networks. Such devices are available in a variety of compact form factors, allowing such devices to be held by a single hand and placed in a pocket.

As mobile computing devices become smaller, it may be easier to lose them. However, it is desirable for the mobile device to be small so that it can be easily carried by a user between different places. The small mobile computing device, which is desirable in so many other ways, is easy to put down and forget and in general, easier to misplace. In addition, apart from the mobile devices being expensive to replace, it may carry confidential and sensitive data Thus, since users may often lose their mobile devices and have no way of finding them, it may be advantageous to minimize such instances of mobile device misplacement.

### SUMMARY

In one aspect, a method for notifying a mobile device owner or other rightful user of a misplaced mobile computing device is provided. The method comprises a computer receiving social networking information about the owner of the mobile device. The method further comprises the computer receiving, from the mobile computing device, a set of contextual information that is associated with the mobile computing device. The method further comprises the computer determining, based on the set of contextual information, whether the mobile computing device has been misplaced. The method further comprises, in response to the computer determining that the mobile computing device has been misplaced, the computer dynamically identifying, based on the set of contextual information and on the social networking information, one or more contacts associated with the owner. The method further comprises, in response to the computer determining that the mobile computing device has been misplaced, the computer sending a notification message to the identified one or more contacts. The notification message indicates that the owner's mobile computing device has been misplaced.

In another aspect, a computer program product for notifying a mobile device owner or other rightful user of a misplaced mobile computing device is provided. The computer program product comprises one or more computer-readable tangible storage devices and a plurality of program instructions stored on at least one of the one or more computer-readable tangible storage devices for execution by at least one of one or more processors. The plurality of program instructions comprises program instructions to receive social networking information about the owner of the mobile computing device. The plurality of program instructions further comprises program instructions to receive, from the mobile computing device, a set of contextual information that is associated with the mobile computing device. The plurality of program instructions further comprises program instructions to determine, based on the set of contextual information, whether the mobile computing device has been misplaced. The plurality of program instructions further comprises program instructions to, in response to determining that the mobile computing device has been misplaced, dynamically identify, based on the set of contextual information and on the social networking information, one or more contacts associated with the owner. The plurality of program instructions further comprises program instructions to, in response to determining that the mobile computing device has been misplaced, send a notification message to the identified one or more contacts. The notification message indicates that the owner's mobile computing device has been misplaced.

In another aspect, a computer system for notifying a mobile device owner or other rightful user of a misplaced mobile computing device is provided. The computer system comprises one or more processors, one or more computer-readable tangible storage devices, and a plurality of program instructions stored on at least one of the one or more storage devices for execution by at least one of the one or more processors. The plurality of program instructions comprises program instructions to receive social networking information about the owner of the mobile computing device. The plurality of program instructions further comprises program instructions to receive, from the mobile computing device, a set of contextual information that is associated with the mobile computing device. The plurality of program instructions further comprises program instructions to determine, based on the set of contextual information, whether the mobile computing device has been misplaced. The plurality of program instructions further comprises program instructions to, in response to determining that the mobile computing device has been misplaced, dynamically identify, based on the set of contextual information and on the social networking information, one or more contacts associated with the owner. The plurality of program instructions further comprises program instructions to, in response to determining that the mobile computing device has been misplaced, send a notification message to the identified one or more contacts. The notification message indicates that the owner's mobile computing device has been misplaced.

### BRIEF DESCRIPTION OF THE SEVERAL VIEWS OF THE DRAWINGS

FIG. 1 is an illustration of a distributed data processing environment for notifying a mobile device owner of a misplaced mobile device in accordance with an embodiment of the present invention.

FIG. 2 is an exemplary illustrative view of a misplacement detecting system constructed according to an embodiment of the present invention.

FIG. 3 illustrates steps performed by a misplacement detector program for detecting a misplacement of a mobile device, according to an embodiment of the present invention.

FIG. 4 illustrates steps performed by a misplacement analyzer program for identifying a most suitable contact of the owner to notify of a misplaced mobile device, according to an embodiment of the present invention.

FIG. 5 illustrates steps performed by a notification manager program for notifying the identified best contact of a misplaced mobile device, according to an embodiment of the present invention.

FIG. 6 is an exemplary screen of a mobile device misplacement notification, according to an embodiment of the present invention

FIG. 7 is a block diagram of internal and external components of each of the computers of FIG. 1.

### DETAILED DESCRIPTION

The following described exemplary embodiments utilize accessible information to locate a lost or misplaced mobile device. One such source of accessible information may, for example, include social networking information. For example, social networks such as MYSPACE®, FACEBOOK®, and TWITTER® (MYSPACE® is a registered trademark of MySpace Inc., located in Beverly Hills, Calif.; FACEBOOK® is a registered trademark of Facebook, Inc., located in Palo Alto, Calif.; TWITTER® is a registered trademark of Twitter, Inc. located in San Francisco, Calif.) have become an increasingly popular way for internet users to interact with friends and share information online. Social network users have the ability to easily share information with others in their social network.

For example, social networks provide tools such as automatically generated newsfeeds and minifeeds that display the online activities of users and people in the user's social network, and simple-to-use ‘invite friends’ features allow a social network user to easily invite friends in the user's social network to join an event or action or even invite friends not currently participating in a social network to join that social network and the event. Thus, as described in following, in situations where a rightful user misplaces their device, social networking data can be utilized as a mechanism for locating the rightful user and determining a friend or contact that can notify the rightful user (that their device has been misplaced) in the most expeditious and effective way.

Embodiments of the present invention will now be described with reference to the figures. In brief summary, an embodiment of the invention may be practiced in the context of a rightful user misplacing her mobile device. As used herein, a misplaced device may be any device that is, for any reason, no longer in the possession or control of its rightful user. A rightful user may be anyone who is entitled to rightfully possess or have custody of a device, such as the owner of the device or a user who has been leant the device, such as a child whose parent has provided the device to her for her use. It is noted that terms “rightful user” and “owner” may be used interchangeably herein. It is recognized that in today's society, people routinely transport their mobile devices (along with a variety of personal items, such as car keys, wallets, purses, brief cases, umbrellas, and the like) throughout many different locations during the course of the day, for example, home, office, restaurant, hotel, and the like. Consequently, recovery of a misplaced mobile device can be difficult (or at best, inconvenient), assuming the person even realizes that the mobile device is not within their immediate possession.

According to an embodiment of the invention, a mobile device may include a monitoring program. The monitoring program may operate to detect a potential misplacement of the mobile device based on communication, such as radio frequency communication, between the mobile device and other personal items having identification tags. In certain embodiments, personal items can include any type of movable objects that can be affixed with the tags. In addition, the monitoring program may be operable to gather contextual information from the mobile device. In response to detecting a potential misplacement, the monitoring program may send a signal along with the gathered contextual information to a remote server indicating that a mobile device may not be within the immediate possession of its rightful user. According to an embodiment of the invention, the remote server may include one or more programs operable to evaluate the provided contextual information and rightful user's social networking information in order to notify a person affiliated with the rightful user who is most likely to assist the rightful user in the fastest recovery of the misplaced mobile device.

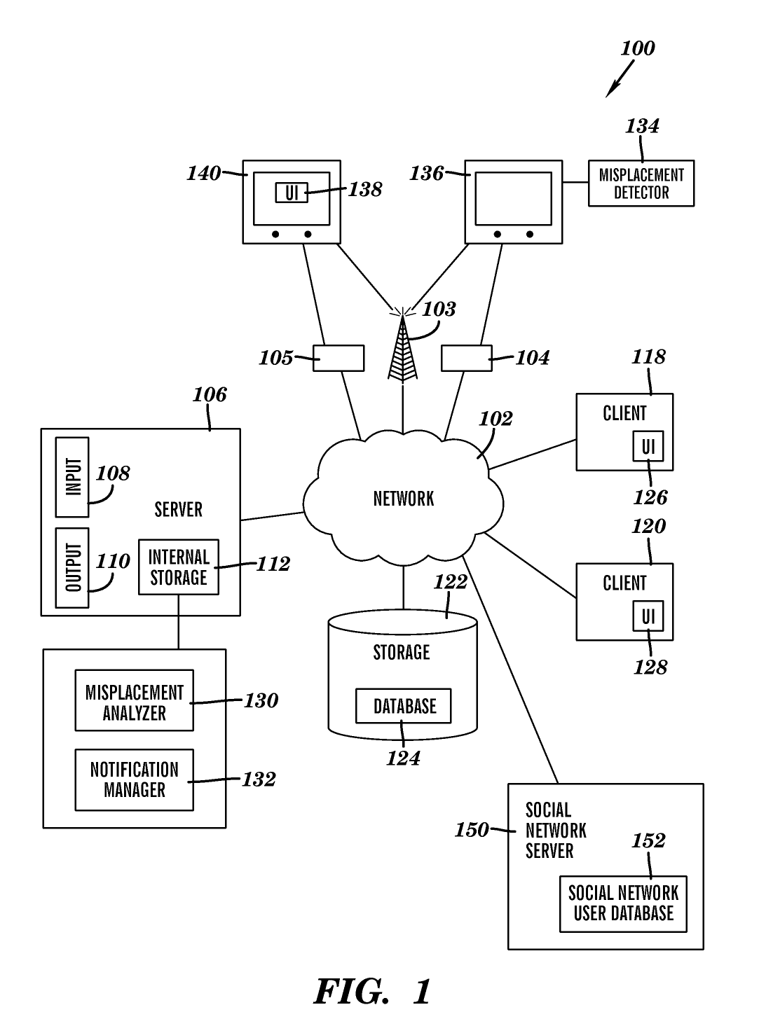

FIG. 1 is an illustration of a distributed computer system 100 in accordance with an embodiment of the present invention. FIG. 1 is intended as an exemplary embodiment, not as an architectural limitation for different embodiments of the present invention, and therefore, the particular elements shown in FIG. 1 should not be considered limiting with regard to the environments in which the illustrative embodiments of the present invention may be implemented. Distributed computer system 100 may include a network 102, a server computer 106, client computers 118 and 120 coupled to the server computer 106 via the network 102, a social network server computer 150 coupled to the network 102, and a storage unit 122 also coupled to the network 102. Network 102 may include, for example, the Internet.

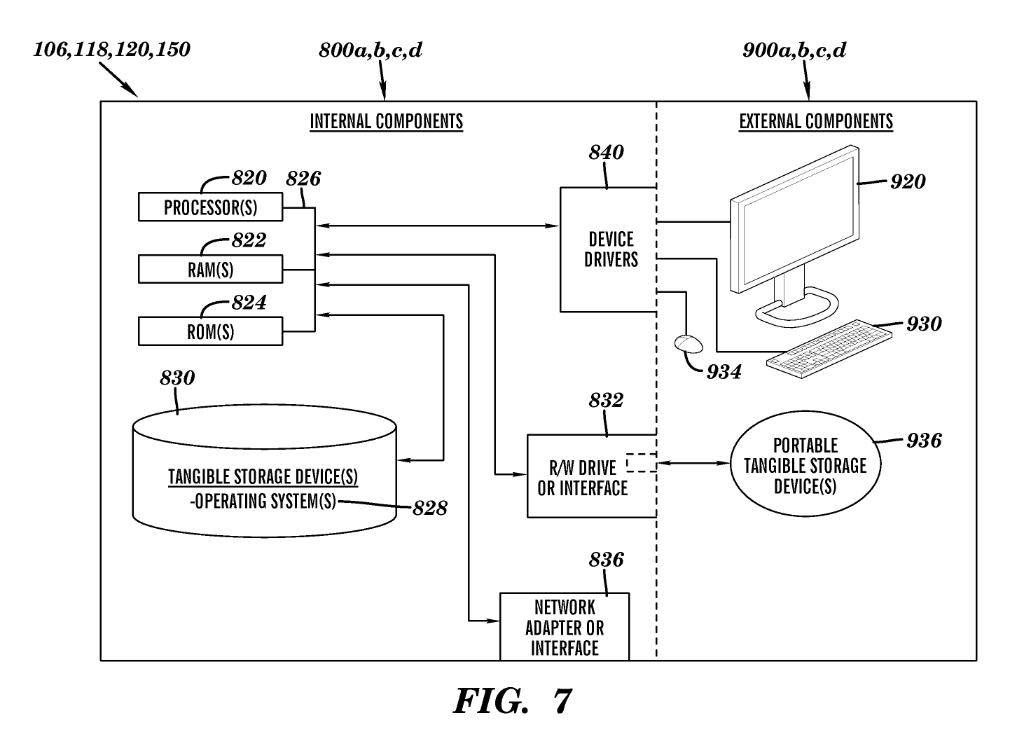

As will be discussed with reference to FIG. 7, server computer 106 includes internal components 800a and external components 900a, client computer 118 includes internal components 800b and external components 900b, client computer 120 includes internal components 800c and external components 900c, and social network server 150 includes internal components 800d and external components 900d. For simplicity purposes, only two client computers 118 and 120 are shown in FIG. 1, although in other embodiments, distributed computer system 100 can include additional client computers. Network 102 represents a worldwide collection of networks and gateways to communicate with one another. Network 102 can be, for example, an intranet, a local area network (LAN), a wide area network (WAN), a wireless local area network (WLAN), a synchronous optical network (SONET), and the like Network 102 may include communication connections, such as wire, wireless communication links, or fiber optic cables.

In the illustrated example, server computer 106, cellular tower 103, and access points 104 and 105 may be interconnected and may be included within wireless service provider's infrastructure. In an embodiment of the present invention, first mobile device 136 and second mobile device 140 may include, but are not limited to, a cellular phone, a smartphone, a personal digital assistant (“PDA), a handheld gaming device, and the like that can communicate with cell tower 103 and access points 104 and 105. In the illustrated example, a first user may own or otherwise use or control a misplaced device (first mobile device 136), while a second user may be a rightful user of the second mobile device 140. If first mobile device 136 and second mobile device 140 are wireless VoIP (Voice over Internet Protocol) phones or have Unlicensed Mobile Access (UMA)/General Access Network (GAN) capability, they may also communicate with access points 104 and 105.

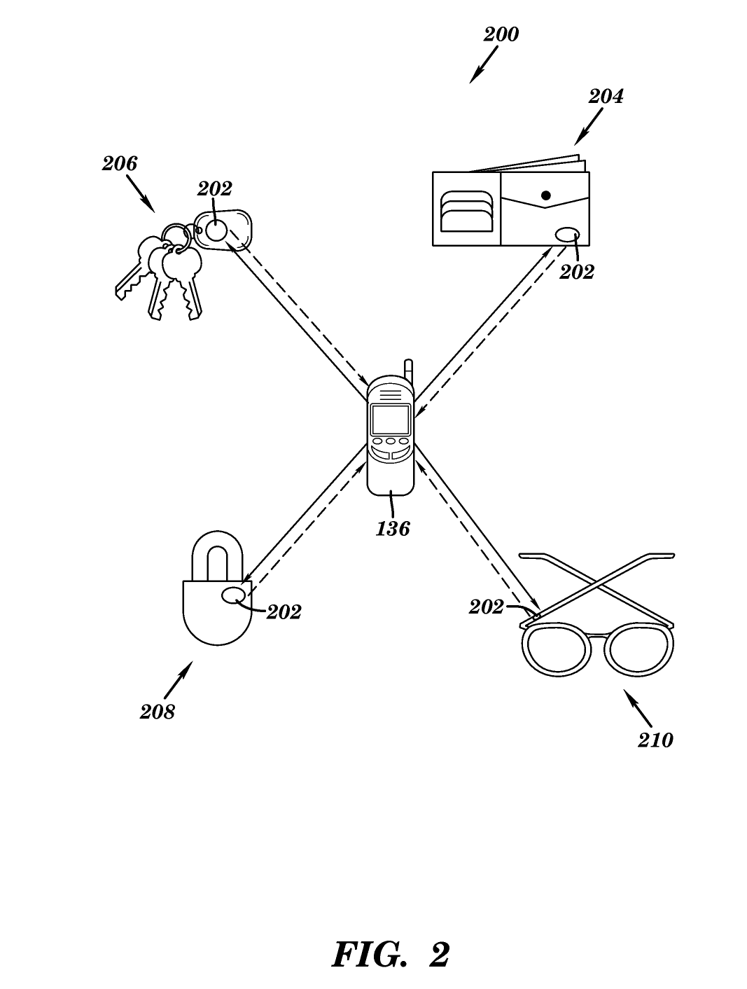

Mobile devices 136 and 140 may wirelessly communicate via any known wireless protocols, including, for example, WiMAX® (Worldwide Interoperability for Microwave Access) (WiMAX® is a registered trademark of the WiMAX Forum, located in Mountain View, Calif.), Bluetooth® (Bluetooth® is a registered trademark of the Bluetooth SIG, located in Kirkland, Wash.) and other protocols. First mobile device 136 may communicate with one or more servers within the wireless server provider's infrastructure with, for example, server computer 106. According to an embodiment of the present invention, first mobile device 136 may include a misplacement detector program 134. Misplacement detector program 134 may operate to detect a potential misplacement of the first mobile device 136 based on communication, such as radio frequency communications, between the mobile device and other personal items (not shown in FIG. 1) having identification tags, as will be discussed with reference to FIG. 2.

The exemplary access points 104 and 105 may include hardware such as a modulator/demodulator (modem), antenna, processor, and memory. The modem may be configured to receive data from a router connected to network 102 and convert the received data into a modulated Radio Frequency (RF) signal such as a 802.11 compliant modulated RF signal. The antenna may communicate the modulated RF signal wirelessly to one or more mobile devices, such as first mobile device 136 and second mobile device 140 within a range associated with access points 103 and 104. The antenna may further be configured to receive RF-modulated data from first and second mobile devices 136 and 140, respectively.

Server computer 106 may be a workstation, a mainframe computer, a personal computer, and the like. Server computer 106 may contain an input 108 and output 110 (an I/O device). Misplacement analyzer program 130 and notification manager program 132 may be stored on one or more computer readable storage devices, such as internal storage 112 on server computer 106. The misplacement analyzer program 130 and the notification manager program 132 may be downloaded from the storage devices to server computer 106 over network 102 for use in mobile device misplacement analysis.

In an embodiment of the present invention, misplacement analyzer program 130 operates to confirm the misplacement of a mobile device (for example, first mobile device 136) based on provided contextual information. Furthermore, misplacement analyzer program 130 operates to identify the most suitable person (contact affiliated with the first user) to notify of the misplaced mobile device. Notification manager program 132 operates to transmit a notification to the identified most suitable or best contact indicating that the first user has misplaced her mobile device. It is noted that terms “most suitable contact” and “best contact” may be used interchangeably herein. In one embodiment, misplacement analyzer program 130 and notification manager program 132 run on the same server 106, as shown in FIG. 1. However, in various embodiments it may be necessary or desirable to run one or more of misplacement analyzer program 130 and notification manager program 132 on different servers.

Data gathered, generated, and maintained for use by various programs listed herein may be kept in internal storage 112 of server computer 106 or in one or more databases 124 of storage unit 122.

Social network server computer 150 may be any combination of software agents and/or hardware modules for establishing a social network-based platform for users. Social network server computer 150 may facilitate interaction among users of client computers 118 and 120 with other related applications and/or systems via the network 102. For example, social network server computer 150 may provide a platform for users of the client computer 118 who are members of the social network to upload photos, notes, calendar events, and the like to share with other users, such as, for example, users of client computer 120 who are also members of the same social network. In one embodiment, social network server computer 150 may facilitate sharing of information about activities of the first user with the second user (a rightful user of the second mobile device 140). It is contemplated that the first and second users may be designated as friends within the social network. The functionality of the social network-based platform may also be distributed across multiple servers disposed across the network 102. The information about social network users may be stored in a social network user database 152.

In the depicted example, client computers 118 and 120 may be, for example, a netbook, laptop computer, tablet computer, desktop computer, or any type of computing devices capable of executing software in accordance with the embodiments described herein. Client computers 118 and 120 may contain user interfaces (UIs) 126 and 128, respectively. UIs 126 and 128 can be, for example, graphical user interface (GUI) or web user interfaces (WUI). UI 126 may provide the first user with an opportunity to access data gathered, generated, and maintained for use by various programs listed herein.

In the illustrated example, data is communicated between server computer 106 and client computer 118 using a standard protocol such as Hyper Text Transfer Protocol (HTTP), File Transfer Protocol (FTP), Simple Object Access Protocol (SOAP) over HTTP, or the like. Distributed computer system 100 may include additional server computers, client computers, displays and other devices not shown.

FIG. 2 is an exemplary illustrative view of a misplacement detecting system constructed according to an embodiment of the present invention. FIG. 2 illustrates scenarios whereby tracking of a mobile device can be performed using tags. The term “tag” or bearer tag refers to a chip, smart card, transponder, contactless card, near field communication (NFC) tag, radio frequency identification (RFID) tag, a wireless communication enabled device (for example, BLUETOOTH® device, Wi-Fi device, and the like). In certain embodiments, personal items can include any type of movable objects that can be affixed with the tags. For example, these items can include personal effects (for example, wallet, purse, umbrella, watch, suitcase, and the like), electronics (for example, laptop), or other personal possessions (for example, bicycle, golf bag, sports equipment, and the like). In this manner, tag identifiers may embody, for instance, a code, parameter, value, etc., that distinctly identifies one tag from another. Depending on, for example, the value and/or size of an item, different tags can be utilized. It should be appreciated that any number and kind of items may be tagged. In the particular embodiment illustrated in FIG. 2 radio frequency identification tags (RFID tags) 202 are employed. Used herein, the term “radio frequency identification tag” refers to any device which wirelessly transmits an identification signal in response to a wireless query signal. As previously indicated, mobile device 136 may be a cellular phone. Generally speaking, both RFID tags and mobile devices use UHF frequencies. Because the frequencies of typical RFID tags and mobile devices already have a transmitter/receiver located therein, RFID tags may be ideal for tracking a misplaced mobile device.

The RFID tags 202 of the embodiment of the present invention may include a small electronic chip (not shown) with a radio frequency transponder (not shown). Preferably, the RFID tags 202 include an adhesive sticker having the electronic chip embedded therein. The RFID tags 202 may then be adhesively attached to any number of items, for example, a wallet 204, keys 206, a purse 208, and glasses 210. It should be appreciated, however, that any number and kind of items may be tagged. Alternatively, the RFID tags 202 may be already imbedded in the personal items directly.

In an embodiment of the present invention, an item list of personal items may be maintained, for example, in database 124. The item list may be presented to the first user through the UI 126. The menu may allow the first user to manage the item list stored in database 124. The item list may contain records, each record corresponding to a personal item. In an embodiment of the present invention, each record may include an RFID, a name of the personal item, and a location of the personal item. The RFID corresponds to the RFID tag attached to the personal item. The first user may add new personal items to the item list through the UI 126. The menu in the UI 126 may allow the first user to enter the RFID associated with a personal item and the name to be associated with a personal item. Furthermore, UI 126 may allow the first user to change the names of personal items in the item list, to change the RFID of personal items in the item list, or to delete records from the item list.

In an embodiment of the present invention, UI 126 may also allow the first user to create one or more lists of personal items belonging to family members. For example, for each family member the first user may enter a person's name, a personal item, and an RFID corresponding to the personal item. The family item list may be stored in the database 124. In an embodiment of the present invention, misplacement detector program 134 may employ the first user's personal items list along with family members' lists to detect whether the first mobile device 136 has been misplaced.

In an embodiment of the present invention, mobile device 136 emits a radio signal that is received by the RFID tags 202. The electronic radio frequency transponder located within the RFID tags 202 in turn responds with a returning radio signal. This returning radio signal from the RFID tags 202 is received by mobile device 136.

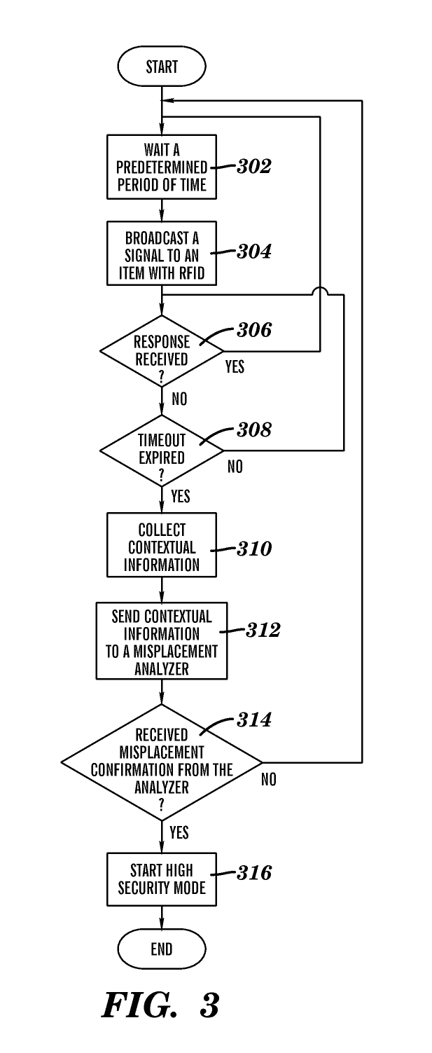

FIG. 3 illustrates steps performed by a misplacement detector program for detecting a misplacement of a mobile device, according to an embodiment of the present invention. In an embodiment of the present invention, the misplacement detector program 134 may be implemented as a mobile device application that facilitates misplacement detection of the first mobile device 136. The misplacement detector program 134 may be a thin client application based on J2ME® (J2ME® is a registered trademark of Oracle America Inc., located in Redwood Shores, Calif.), or BREW® (BREW® is a registered trademark of Qualcom Inc., located in San Diego, Calif.) platform, that is downloaded on (or that is otherwise installed as original equipment in) the first mobile device 136. The first user also may obtain the misplacement detector program 134 in response to receiving an invitation, such as an advertisement, a text message, or the like. First mobile device 136 may include an RFID reader (not shown). The RFID reader may wirelessly communicate with RFID tags 202 within its coverage area. In an embodiment, the misplacement detector program 134 may periodically transmit a signal using the RFID reader. At 302, the misplacement detector program 134 may wait a predetermined period of time. In an embodiment, the predetermined period of time may be equal to about one minute. At 304, the misplacement detector program 134, to verify the presence of personal items from the personal item list(s), may generate a poll message which may be broadcasted. A variety of known transmission techniques can be used for communication between the first mobile device 136 and a plurality of RFID tags 202 attached to a plurality of personal items. For example, techniques such as, but not limited to, Frequency Shift Keying (FSK) with transmissions generally comprised between 124.2 kHz and 134.2 kHz may be used. This technique has comparatively good resistance to noise while also being very cost effective to implement. Frequencies utilized for communication between first mobile device 136 and RFID tags 202 are not limited to particular ranges. It is contemplated that various exemplary embodiments are also applicable to other equivalent proximity-based identification technologies. When RFID tags 202 in the broadcast range of first mobile device 136 receive the poll message, they each separately generate and transmit a response message which provides their tag data associated with a corresponding personal item. When the broadcast signal (for example, power pulse) has been received, the RFID tag 202 immediately transmits back an identifier (RFID) associated with the corresponding item.

At 306, the misplacement detector program 134 may determine whether the RFID reader received a response from at least one tag included in the personal item list stored in the database 124. In response to the RFID reader receiving at least one response, the misplacement detector program 134 may analyze the received response messages for the tag data of detected RFID tags. If the received data matches data associated with one or more items in the list, the misplacement detector program 130 may return back to 302. In response to determining that no RFID response has been received by the RFID reader (decision 306, no branch) the misplacement detector program 130 may check whether the predetermined timeout period has expired. In an embodiment, the predetermined timeout period may be a configurable parameter which provides a limit for waiting for responses from any RFID tags. In an embodiment the predetermined timeout period may be equal to 10 seconds. If the timeout period has not expired (decision 308, no branch), the misplacement detector program 130 may return to 306.

If at 308, the misplacement detector program 130 determines that the predetermined timeout period has expired and no response has been received (decision 308, yes branch), the absence of personal items in the broadcast range of the first mobile device 136 may indicate that the first mobile device 136 might be misplaced. Consequently, at 310, the misplacement detector program 134 may gather contextual information from the first mobile device's 136 sensors, interfaces and apps. The subset of contextual information relating to the first mobile device 136 may include many different items of information about the first mobile device 136. In an embodiment of the present invention, the first mobile device 136 may include a satellite navigation system, for example, a GPS (Global Positioning System) receiver chipset which can determine geographic longitude and latitude. Other satellite navigation systems that may be used include the Galileo positioning system in use in Europe, the GLONASS positioning system in use in Russia, and the Compass navigation system in use in China. According to an embodiment of the invention, some of the apps installed on the first mobile device 136 may include applications which enable the first user to better manage scheduling and communications, and other such tasks. Some commonly available applications include scheduling and calendar programs, task lists, address books, and electronic (e-mail) programs. In addition, first mobile device 136 may store information regarding the first user's service usage patterns, what services the first user uses, and how often each service is utilized. Furthermore, the first mobile device 136 may include a near field communication (NFC) adapter associated with it. Typically, NFC adapter enables a mobile device to communicate with other NFC devices. Consequently, contextual information gathered by the misplacement detector program 130 may include current geographic location, calendar events, current state of each service subscribed to by the first user, recently exchanged NFC information, or the like.

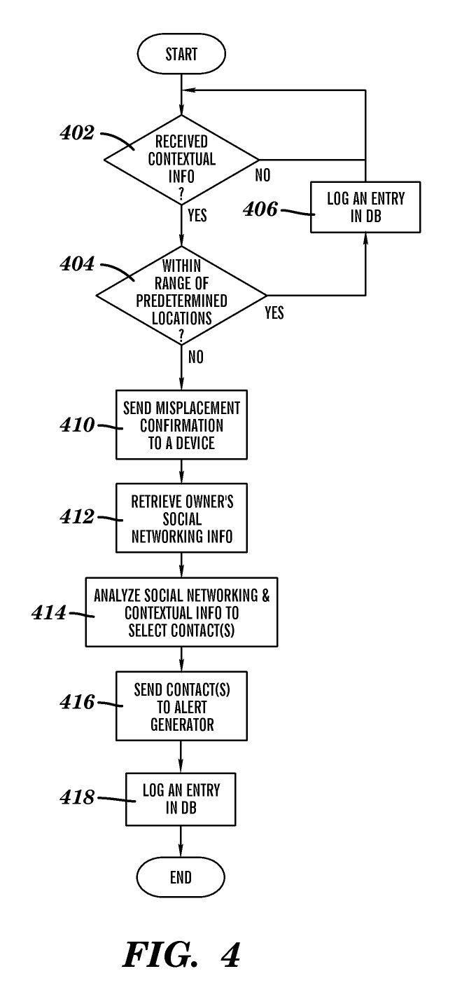

Next, at 312, the misplacement detector program 134 may generate a request, containing, in one embodiment, the gathered contextual information pertaining to the first mobile device 136, and may transmit the same to the misplacement analyzer program 130. In response, the misplacement analyzer program 130 may analyze the contextual information as described below in conjunction with FIG. 4. After transmitting the request, the misplacement detector program 134 may wait for a misplacement confirmation message from the misplacement analyzer program 130. In response to receiving such confirmation message (decision 314, yes branch), the misplacement detector program 132 may initiate a high security mode. Otherwise (i.e., if the misplacement analyzer program 130 determined that the first mobile device 136 has not actually been misplaced—decision 314, no branch), the misplacement detector program 130 may return to 302. In an embodiment of the present invention, initiating a high security mode may include executing a script to disable one or more features of the first mobile device 136. It is contemplated that the disabling script is executed after a misplacement condition is confirmed by the misplacement analyzer program 130. The origin of the disabling script may vary in different embodiments of the present invention. In an embodiment, the disabling script may be stored in the memory of the first mobile device 136. Examples of functions that may be performed by a disabling script are the following: disabling the telephone function or other communications functions (such as short messaging service) of the first mobile device 136, disabling a personal organizer function of the first mobile device 136, executing other operations to permanently or temporarily disable all or part of the first mobile device 136, executing other operations to delete, encrypt, or otherwise render inaccessible any private data, or the like.

FIG. 4 illustrates steps performed by the misplacement analyzer program 130 for performing misplacement confirmation function and for identifying a most suitable contact to notify of a misplaced mobile device, according to an embodiment of the present invention. At 402, the misplacement analyzer program 130 may wait for a request containing contextual information from the misplacement detector program 134 to arrive. In response to receiving the request (decision 402, yes branch), at 404, the misplacement analyzer program 130 may determine if the first mobile device 136 is at its “home location”. A mobile device's home location is defined as the actual or approximate physical location at which the mobile device usually resides, as determined by contextual information and other device characteristics that are present when the mobile device is at its usual residence. In an embodiment of the present invention, contextual information may include collected location information such as in-range wireless access point (Wi-Fi) signal strengths, in-range cell tower signal strengths and in-range cell tower signal arrival timing information, or the like. This location information collectively forms a current location profile for first mobile device 136 and indicates the current geographical location of first mobile device 136. At 404, misplacement analyzer program 130 may compare the current location profile against the first mobile device 136 home location profile, which may be collected by misplacement detector program 134 in the same manner as a current location profile while the first mobile device 136 is at its home location. In various embodiments, multiple “home location” profiles (such as first user's home, first user's office, and the like) may be stored in database 124 and a match on any stored profile will cause misplacement analyzer program 130 to indicate that first mobile device 136 is at its home location and that misplacement has not actually occurred. In one embodiment, home location profiles may reside in database 124. In other embodiments, home location profiles can reside in internal storage 112 of server computer 106, or on a remote computer, such as client computer 118. In general, home location profiles can reside anywhere within distributed computer system 100, provided they are accessible to misplacement analyzer program 130.

If there is a sufficient match between the current location profile and the home location profile stored in database 124, then misplacement analyzer program 130 will indicate a match and return a value indicating that misplacement has not happened to the misplacement detector program 134. What constitutes a sufficient match can be determined in a variety of ways and is an implementation decision. For example, longitude and latitude coordinates determined from a satellite navigation system are considered to be very reliable, and can determine the geographical location of a satellite navigation system enabled device to within a few meters. Thus, one method for determining whether first mobile device 136 is at its home location is to rely solely on satellite navigation system (such as GPS) coordinates if this information is available for both current and home location profiles. If, for example, the home location is represented by a satellite navigation system location of the first mobile device 136 when at the first user's residence or office, the home location could be a predetermined radius (for example, corresponding to the perimeter of the residence building or office room) from that satellite navigation system location. If the current location as determined by satellite navigation system information in the current location profile indicates that first mobile device 136 is within the predetermined radius, then misplacement analyzer program 130 will consider first mobile device 136 to be at its home location.

In response to determining that first mobile device 136 is located within the predetermined radius of one of the home locations (decision 404, yes branch), misplacement analyzer program 130, at 406, may create an entry in database 122 indicating the determined current location of the first mobile device 136. Subsequently, misplacement analyzer program 130 may return to 402 to wait for the next request.

In response to determining that first mobile device 136 is not located within the predetermined radius of one of the home locations (decision 404, no branch), misplacement analyzer program 130, at 410, may return a value confirming the misplacement of the first mobile device 136 to the misplacement detector program 134. At least in some embodiments, misplacement analyzer program 130 may attempt to deduce (e.g. by using contextual information and/or heuristics) the likely current location of the first mobile device. For example, in an embodiment of the present invention, misplacement analyzer program 130 may use calendar information (such as, conference room number/location) collectively with GPS coordinates, if available, to pinpoint the exact location of the first mobile device. In an exemplary embodiment of the present invention, at this point, misplacement analyzer program 130 may proceed with analyzing first user's social networking information to determine the best contact to inform regarding the misplacement of first mobile device 136.

Generally, to join a social networking system a user may complete a registration page and enter a valid email address as a unique identifier, plus a private password. The user then may set up her profile and enter her contacts. The profile may describe the user's background, experience, current and prior interests, capabilities, positions and titles, skills, values, projects, goals, etc. The user can add contacts to her network by entering contact and relationship information, and profile information for the contact, or a link to the contact's own profile on the social networking system. The contact information may also be automatically uploaded or extracted from other sources such as an electronic address book. The profile and contact information may be stored in a social network user database.

According to some embodiments of the present invention, the social network server 150 may be able to store and retrieve data from the social network user database 152. In some embodiments of the present invention, social network server computer 150 may be able to provide and store the profile and contact information in database 124 via the network 102.

At 412, misplacement analyzer program 130 may retrieve the first user's social networking profile and contacts information from database 124. At 414, misplacement analyzer program 130 may collectively analyze retrieved social networking information and contextual information to identify one or more contacts that may be in communication with a rightful user of a misplaced device. Typically, that would be someone who is still in the vicinity of the rightful user or soon will be. For example, contextual information gathered by misplacement detector program 134 may include calendar events. The first user may have a note in her “to-do” list among her calendar events that says “Call second user.” In addition, the first user may have an appointment with second user at 3:00 p.m. stored in the first user's calendar. Furthermore, misplacement analyzer program 130 may determine that second user is a member of the same social network as the first user. Social networking information stored in database 124 may also include second user's contact information. If misplacement analyzer program 130 determines that first mobile device was misplaced around 3:00 p.m. then misplacement analyzer program 130 may identify second user as a best contact to notify that the first user might have misplaced her device. In addition, if contextual information includes geographic coordinates and/or approximate current location of the misplaced device, that information may be included in the notification, as described below. It should be noted that in various embodiments, misplacement analyzer program 130 may select more than one contact. For example, in response to determining, based on social networking information, that first user may be attending a sporting event with a group of her friends, provided that the misplacement analyzer program 130 has access to profile information of other group members, misplacement analyzer program 130 may select all group members as potential recipients of a notification alert. Furthermore, while best contact may be an individual person, at least in some embodiments, best contact may include other entities. For example, if misplacement analyzer program 130 determines that the first user is travelling in her vehicle and the vehicle is equipped with, for example, ONSTAR® system, misplacement analyzer program 130 may select the ONSTAR® service center as the most suitable entity to notify. ONSTAR® is a registered trademark of OnStar Corporation of Troy, Mich.

At 416, in response to identifying one or more first user's contacts (for example, second user) as targets for notification purposes, misplacement analyzer program 130 may transmit information associated with the identified contacts to notification manager program 132. Next, at 418, misplacement analyzer program 130 may create a record in database 124 which may contain all relevant information associated with the identified notification recipient (second user).

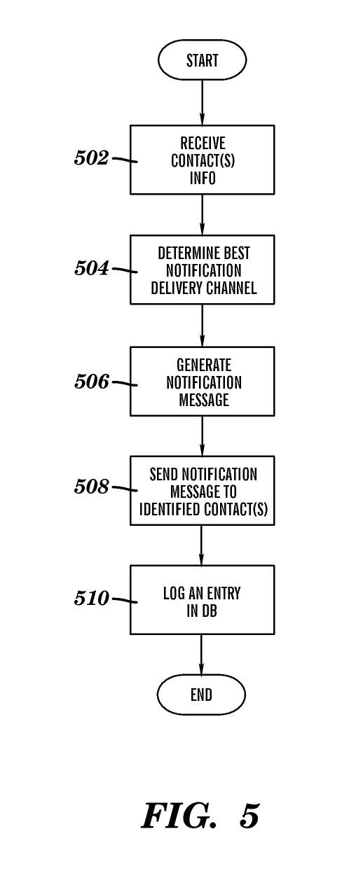

FIG. 5 illustrates the steps performed by a notification manager program for notifying the identified best contact of a misplaced mobile device, according to an embodiment of the present invention. At 502, notification manager program 132 may receive information related to the identified notification recipient from the misplacement analyzer program 130. The received information may include the identified recipient's mobile device 140 number, email address, username, and the like. At 504, notification manager program 132 may dynamically determine the best notification delivery channel based on, for example, contact profile information stored in database 124. Various notification delivery channels may include, but not limited to, SMS (short message service) messages, MMS (multimedia message service) messages, email messages, and social networking based channels, such as Twitter® and Facebook®. For example, notification manager program 132 may obtain a phone number corresponding to the second mobile device 140 based on second user's social networking profile information. Moreover, contextual information gathered by misplacement detector program 134 may indicate that one or more SMS messages were exchanged recently between the first mobile device 136 and the second mobile device 140. In this scenario, notification manager program 132 may select SMS messaging as the best notification delivery channel.

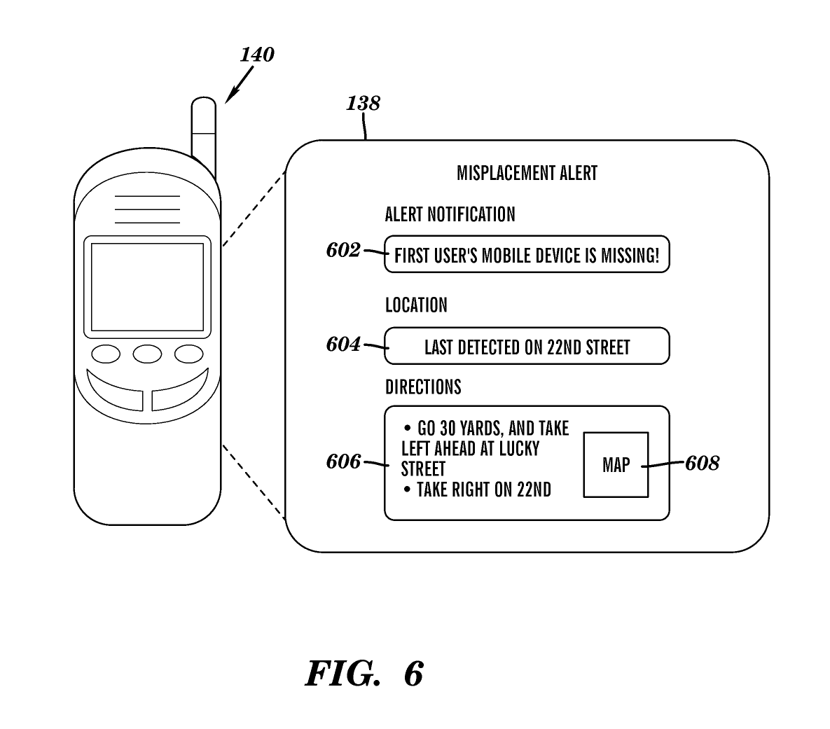

At 506, notification manager program 132 may generate a notification message. As described below in conjunction with FIG. 6, the notification message may indicate that the first user has misplaced her device and have some details on the, for example, determined current location of the first mobile device 136. In various embodiments, notification manager program 132 may provide different type of notifications based on the length of time the first device is considered misplaced. At 508, notification manager program 132 may send the generated notification message to the identified recipient (best contact). The notification may be sent using the selected notification delivery channel, such as SMS, MMS, email, or the like. The second user may receive the notification via his mobile device (second mobile device 140) or client computer 120. FIG. 6 shows an example of what the second user may see on her mobile device when she receives the notification. At 510, notification manager program 132 may create a record in the database 124 that may include various information associated with the sent notification, such as, for example, notification delivery channel, intended recipient's phone number, username, notification text, and the like.

FIG. 6 illustrates an exemplary notification that may be generated by notification manager program 132. Continuing with the example of FIGS. 1-5, it is assumed that the first user has misplaced first mobile device 136, the first user has moved away from the first mobile device 136, and that misplacement analyzer program 130 has selected second mobile device 140 which belongs to the second user as a destination for a misplacement notification. Under this scenario UI 138 in second mobile device 140 may display a notification box 602 which provides the following information: “First user's mobile device is missing!” In addition, the box 604 may indicate the last location in which presence of the mobile device was detected: “Last detected on 22^{nd} Street”. According to one embodiment, GUI 138 may provide a directions box 606, which may instruct the second user how to proceed to the location where the item was last detected. For instance, the following directions may be provided: “Go 30 yards, and take a left ahead at Lucky Street. Take right on 22^{nd}.” In addition, a map display 608 can be supplied to the second user. If, for example, the first and second users are travelling together, at this point, advantageously, the second user may communicate the received notification to the first user thereby assisting her to retrieve the first mobile device.

FIG. 7 is a block diagram of internal and external components of each of the computers of FIG. 1. Computers 106, 118, 120 and 150 include respective sets of internal components 800a, b, c, d and external components 900a, b, c, d. Each of the sets of internal components 800a, b, c, d includes one or more processors 820, one or more computer-readable RAMs 822 and one or more computer-readable ROMs 824 on one or more buses 826, one or more guest operating systems 828 and one or more computer-readable tangible storage devices 830. The one or more operating systems 828 are stored on one or more of the computer-readable tangible storage devices 830 for execution by one or more of the processors 820 via one or more of the RAMs 822 (which typically include cache memory). Misplacement analyzer program 130 and notification manager program 132 may be stored on one or more of the computer-readable tangible storage devices 830 of internal components 800a for execution by one or more of the processors 820 of internal components 800a via one or more of the RAMs 822 of internal components 800a. In one embodiment, database 124 is also stored on one or more computer-readable tangible storage devices 830 of internal components 800a. In the embodiment illustrated in FIG. 7, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a,b,c, d also includes a R/W drive or interface 832 to read from and write to one or more portable computer-readable tangible storage devices 936 such as a CD-ROM, DVD, memory stick, magnetic tape, magnetic disk, optical disk or semiconductor storage device. Misplacement analyzer program 130 and notification manager program 132 can be stored on one or more of the portable computer-readable tangible storage devices 936 of external components 900a, read via R/W drive or interface 832 of internal components 800a and loaded into one or more computer-readable tangible storage devices 830 of internal components 800a.

Each set of internal components 800a,b,c, d also includes a network adapter or interface 836 such as a TCP/IP adapter card. Misplacement detector program 134 can be downloaded to first mobile device 136 from an external computer via a network (for example, the Internet, a local area network or other, wide area network) and network adapter or interface 836 of internal components 800a. The network may comprise copper wires, optical fibers, wireless transmission, routers, firewalls, switches, gateway computers and/or edge servers.

Each of the sets of external components 900a,b,c,d includes a computer display monitor 920, a keyboard 930, and a computer mouse 934. Each set of internal components 800a,b,c,d also includes device drivers 840 to interface to computer display monitor 920, keyboard 930 and computer mouse 934. The device drivers 840, R/W drive or interface 832 and network adapter or interface 836 comprise hardware and software (stored in one or more computer-readable tangible storage devices 830 and/or one or more computer-readable ROMs 824).

Misplacement analyzer program 130, notification manager program 132, and misplacement detector program 134 can be written in various programming languages including low-level, high-level, object-oriented or non object-oriented languages. Alternatively, the functions of misplacement analyzer program 130, notification manager program 132, and misplacement detector program 134 can be implemented in whole or in part by computer circuits and other hardware (not shown).

The description above has been presented for illustration purposes only. It is not intended to be an exhaustive description of the possible embodiments. One of ordinary skill in the art will understand that other combinations and embodiments are possible.

What is claimed is:

1. A method for notifying a rightful user of a mobile computing device of a misplaced mobile computing device, the method comprising:
a computer receiving social networking information about the rightful user of the mobile computing device;
the computer receiving, from the mobile computing device, a set of contextual information that is associated with the mobile computing device;
the computer determining, based on the set of contextual information, whether the mobile computing device has been misplaced; and
in response to the computer determining that the mobile computing device has been misplaced, the computer dynamically identifying, based on the set of contextual information and on the social networking information, one or more contacts associated with the rightful user, and sending a notification message to the identified one or more contacts, the notification message indicating that the rightful user's mobile computing device has been misplaced.

2. The method of claim 1, wherein the set of contextual information includes location data corresponding to a detected geographic location of the mobile device.

3. The method of claim 2, wherein the location data comprises global positioning system (GPS) information obtained by the mobile computing device.

4. The method of claim 1, wherein the set of contextual information includes a plurality of calendar events.

5. The method of claim 1, wherein the notification message comprises at least one of an electronic mail (email) message, a multimedia message service (MMS) message, a short message service (SMS) message and an electronic message for a social networking site.

6. The method of claim 4, wherein the computer dynamically identifying the one or more contacts associated with the rightful user includes the computer dynamically analyzing the plurality of calendar events to determine whether the rightful user and the one or more contacts are within a physical proximity of each other at a current time or at a specific future time.

7. The method of claim 1, further comprising, in response to the computer determining that the mobile computing device has been misplaced, the computer sending an alerting signal to the mobile computing device to activate a secure operation mode of the mobile computing device.

8. A computer program product for notifying a rightful user of a mobile computing device of a misplaced mobile computing device, the computer program product comprising one or more computer-readable tangible storage devices and a plurality of program instructions stored on at least one of the one or more computer-readable tangible storage devices, the plurality of program instructions comprising:
program instructions to receive social networking information about the rightful user of the mobile computing device;
program instructions to receive, from the mobile computing device, a set of contextual information that is associated with the mobile computing device;
program instructions to determine, based on the set of contextual information, whether the mobile computing device has been misplaced; and
program instructions to, in response to determining that the mobile computing device has been misplaced, dynamically identify, based on the set of contextual information and on the social networking information, one or more contacts associated with the rightful user, and send a notification message to the identified one or more contacts, the notification message indicating that the rightful user's mobile computing device has been misplaced.

9. The computer program product of claim 8, wherein the set of contextual information includes location data corresponding to a detected geographic location of the mobile device.

10. The computer program product of claim 8, wherein the location data comprises global positioning system (GPS) information obtained by the mobile computing device.

11. The computer program product of claim 8, wherein the set of contextual information includes a plurality of calendar events.

12. The computer program product of claim 8, wherein the notification message comprises at least one of an electronic mail (email) message, a multimedia message service (MMS) message, a short message service (SMS) message and an electronic message for a social networking site.

13. The computer program product of claim 11, wherein the program instructions to dynamically identify the one or more contacts associated with the rightful user include program instructions to dynamically analyze the plurality of calendar events to determine whether the rightful user and the one or more contacts are within a physical proximity of each other at a current time or at a specific future time.

14. The computer program product of claim 8, further comprising program instructions to, in response to determining that the mobile computing device has been misplaced, send an alerting signal to the mobile computing device to activate a secure operation mode of the mobile computing device.

15. A computer system for notifying a rightful user of a mobile computing device of a misplaced mobile computing device, the computer system comprising one or more processors, one or more computer-readable tangible storage devices, and a plurality of program instructions stored on at least one of the one or more storage devices for execution by at least one of the one or more processors, the plurality of program instructions comprising:
program instructions to receive social networking information about the rightful user of the mobile computing device;
program instructions to receive, from the mobile computing device, a set of contextual information that is associated with the mobile computing device;
program instructions to determine, based on the set of contextual information, whether the mobile computing device has been misplaced; and
program instructions to, in response to determining that the mobile computing device has been misplaced, dynamically identify, based on the set of contextual information and on the social networking information, one or more contacts associated with the rightful user, and send a notification message to the identified one or more contacts, the notification message indicating that the rightful user's mobile computing device has been misplaced.

16. The computer system of claim 15, wherein the set of contextual information includes location data corresponding to a detected geographic location of the mobile device.

17. The computer system of claim 15, wherein the location data comprises global positioning system (GPS) information obtained by the mobile computing device.

18. The computer system of claim 15, wherein the set of contextual information includes a plurality of calendar events.

19. The computer system of claim 15, wherein the notification message comprises at least one of an electronic mail (email) message, a multimedia message service (MMS) message, a short message service (SMS) message and an electronic message for a social networking site.

20. The computer system of claim 18, wherein the program instructions to dynamically identify the one or more contacts associated with the rightful user include program instructions to dynamically analyze the plurality of calendar events to determine whether the rightful user and the one or more contacts are within a physical proximity of each other at a current time or at a specific future time.
